(19) United States
(12) Patent Application Publication
(10) Pub. No.: US 2008/0136295 A1
(43) Pub. Date: Jun. 12, 2008

(54) Clothes Drying and Dewrinkling Cabinet

(76) Inventors: Aitor Aizpuru Borda, San Sebastian (ES); Mikel Markotegi Ijurko, Etxarri Aranaz (ES); Iban Rodriguez Olivenza, Mondragon (ES)

Correspondence Address: The Kline Law Firm, 161 Little Pond Lane, Palmyra, VA, 22963-5161, US

(21) Appl. No.: 11/886,409

(22) PCT Filed: Mar. 13, 2006
(86) PCT No.: PCT/ES06/70031

§ 371 Date: Sep. 13, 2007

(30) Foreign Application Priority Data
Mar. 23, 2005 (ES) P 20500676

(51) Int. Cl. A47B 81/00; D06F 35/00; F26B 25/06

(52) U.S. Cl. 312/31; 68/20; 34/202

(57) ABSTRACT

Clothes drying and dewrinkling cabinet that comprises a closed and static enclosure (2) that defines an inner space (3) for housing clothes, said inner space (3) comprising a main area (30) with a plurality of hangers (13), air supply means (4) for circulating an air flow through said inner space (3), the air supply means (4) being disposed beneath the inner space (3), and the cabinet also comprising at least one outlet (10) for the air flow in the upper part of the inner space (3). The cabinet comprises a small basket (11) for depositing small items of clothing, said small basket (11) being disposed in a substantially horizontal manner in the inner space (3) between the outlet (10) and the main area (30), and the small basket (11) having a base that covers the transverse surface of the inner space (3), in such a way that said basket (11) forms, along with the small items of clothing, an air intake area for the air flow that passes through the main area (30).

### TECHNICAL FIELD

The present invention relates to cabinets in which clothes drying and dewrinkling processes are carried out.

### PRIOR ART

Clothes drying cabinets that comprise a closed and static enclosure that defines an inner space for housing clothes are known, and means for supplying air for circulating an air flow through said inner space, as well as means for heating said air flow.

It is important, in both drying cabinets and drying and dewrinkling cabinets, that the air flow that circulates through the interior enclosure is as homogeneous as possible so that the clothes introduced in the cabinet may be dried homogeneously.

There are known cabinets in which the air flow impacts on the inner space of the cabinet laterally, such as the drying cabinets disclosed in EP 0148385 B1, EP 594085 B1 and EP 1294975 B1. In addition, cabinets in which said air flow impacts on the inner space of the cabinet from above are also known, as described for example in EP 556907 B1.

Finally, drying cabinets are also known in which the air flow is made to impact on the inner space of the cabinet from below. EP 816552 B1 discloses a cabinet for treating clothes that comprises means for supplying hot air that transmit the air flow through a grille disposed on one of the sides of the base of the inner space. Furthermore, in the drying cabinet described in EP 60226 A1 and in EP 94356 B1 the air flow is generated from one side of the base of the inner space.

ES 2178538 B1 discloses a clothes drying and dewrinkling cabinet in which the air supply means comprise a fan, a ventilation body, and a diffuser grille, all of them situated beneath the inner space. The outlet of air from the fan is directed towards the interior wall of the ventilation body. Due to the shape of the interior wall of the ventilation body, the air flow rotates inside it and rises to the inner space of the cabinet through the diffuser grille.

Cabinets in which the air flow impacts from below comprise at least one outlet for the air flow in the upper part of the inner space, the air being exhausted through said outlet in exhaust cabinets and the air passing through said outlet being recirculated in condensation cabinets.

### DISCLOSURE OF THE INVENTION

It is the object of the invention to provide a clothes drying and dewrinkling cabinet by means of which a substantially homogeneous distribution of the air flow is obtained.

The clothes drying and dewrinkling cabinet of the invention comprises a closed and static enclosure that defines an inner space for housing clothes, said inner space comprising a main area with a plurality of hangers, and air supply means for making an air flow circulate through said internal area, the air supply means being disposed beneath the inner space, the cabinet also comprising at least one outlet for the air flow in the upper part of the inner space.

The cabinet of the invention also comprises a small basket for depositing small items of clothing, said small basket being disposed in a substantially horizontal manner in the inner space between the outlet and the main area. The small basket has a base that covers the transverse surface of the inner space, in such a way that said small basket forms, along with the small items of clothing, an air intake area for the air flow that passes through the main area. The small basket thus performs a dual function in the cabinet of the invention: firstly it is used to deposit small items of clothing, and secondly it ensures that the air flow that passes through the main area is distributed homogeneously in said main area.

These and other advantages and characteristics of the invention will be made evident in the light of the drawings and the detailed description thereof.

### DESCRIPTION OF THE DRAWINGS

FIG. 1 shows a cross-sectional profile view of an embodiment of the invention.

FIG. 2 is a perspective view of an embodiment of the small basket of the cabinet of the invention.

FIG. 3 is a partial front view of the interior of the cabinet of FIG. 1 with the hangers and the small basket.

FIG. 4 is a perspective view of a row of hangers of the embodiment of FIG. 1, housed in the side guides.

FIG. 5 is a partial front view of the tub of the cabinet of FIG. 1.

FIG. 6 is a partial perspective view of the tub of the cabinet of FIG. 1.

### DETAILED DISCLOSURE OF THE INVENTION

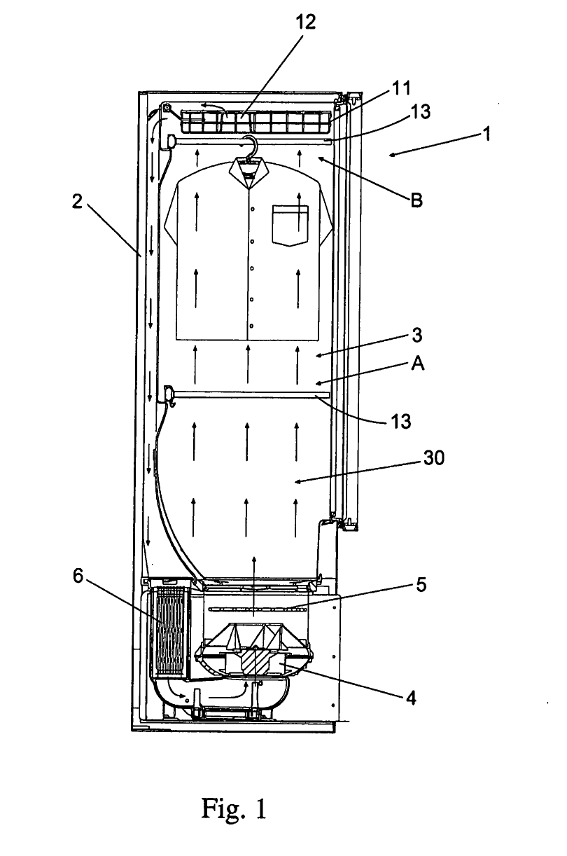

According to the embodiment shown in FIG. 1, the cabinet 1 of the invention comprises a closed and static enclosure 2 that defines an inner space 3 for housing clothes, said inner space 3 comprising a main area 30 with a plurality of hangers 13, and air supply means 4 for circulating an air flow through said inner space 3, the air supply means 4 being disposed beneath the inner space 3. The cabinet 1 also comprises at least one outlet 10 for the air flow in the upper part of the inner space 3.

In this embodiment, the cabinet 1 is of the condensation type, and comprises, therefore, condensation means 6 for condensing the water in the air flow that passes through the inner space 3, said air flow then being recirculated. Although the example of the embodiment refers to a condensation cabinet, it is also applicable to exhaust cabinets.

The cabinet 1 has, disposed in a substantially horizontal manner in the inner space 3 between the outlet 10 and the main area 30, a small basket 11 for depositing small items of clothing, said small basket 11 having a base that covers the transverse surface of the inner space 3. The small basket 11 thus forms, along with the small items of clothing, an air intake area for the air flow that passes through the main area 30. Said air intake area ensures that the air flow is distributed in the main area 30 in a substantially homogeneous manner.

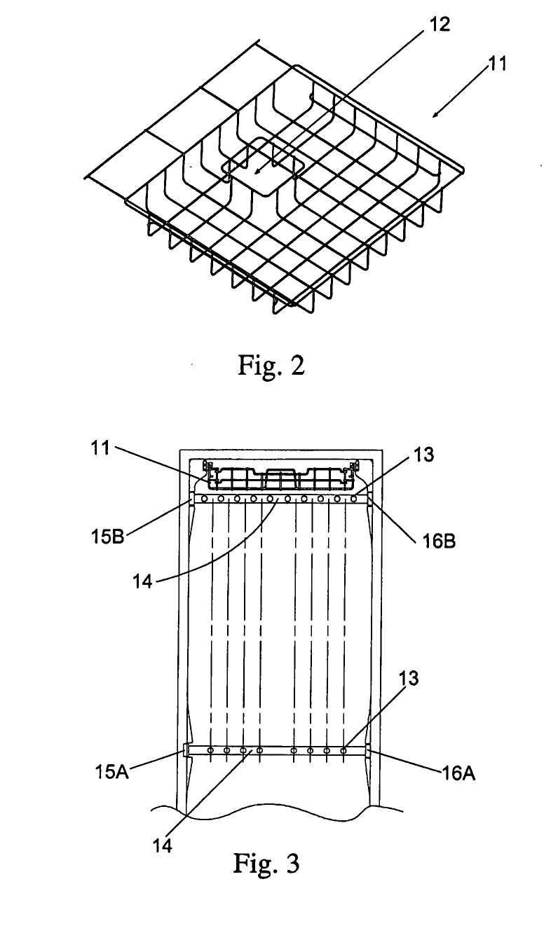

In this embodiment said small basket 11, which may be, for example, similar to that shown in perspective in FIG. 2, delimits a central duct 12. Said central duct 12 helps improve even further the homogeneous distribution of the air flow.

In this embodiment the small basket 11 is a basket made of rods, as a result of which the air flow dries the small items of clothing disposed in the small basket 11. The small basket 11 is extractable and is supported on side guides disposed on the side walls of the enclosure 2.

The outlet 10 of the air flow is disposed on the rear wall of the enclosure 2. In this embodiment, said outlet 10 comprises two mouths each covered by a filter. If the small basket 11 is dispensed with, the air flow that originates from the lower part of the inner space 3 would tend to be directed towards said outlet 10, giving rise to a non-homogeneous distribution of the heat, as a result of which the drying of the clothes would not be homogeneous (drying would occur more quickly in the rear half of the enclosure 2 than the front half of said enclosure 2).

Furthermore, it has been found that greater homogeneity of the air flow can be achieved if the central duct 12 of the small basket 11 is moved towards the outlet 10 in relation to the geometrical centre of the small basket 11.

The hangers 13 for hanging clothes on are distributed in a first row A disposed at medium height and in a second row B disposed in the upper part, just beneath the small basket 11. Although a person skilled in the art would tend to position the hangers 13 of the second row B in alignment with the hangers 13 of the first row A, it has been proven that drying and dewrinkling results are improved if the hangers 13 of the second row B are not in alignment in relation to the hangers of the first row A.

More specifically, the hangers 13 are disposed parallel to each other, and the hangers 13 of the second row B are positioned in such a way that they leave the spaces above the hangers 13 of the first row A free, as shown in FIG. 3. As can be seen in said FIG. 3, the hangers 13 of the second row B are equally spaced and there is, beneath each space between consecutive hangers 13 of said second row B, one hanger 13 of the first row A at most.

In addition, the hangers 13 of the first row A are distributed in such a way that they leave a central space free of hangers 13.

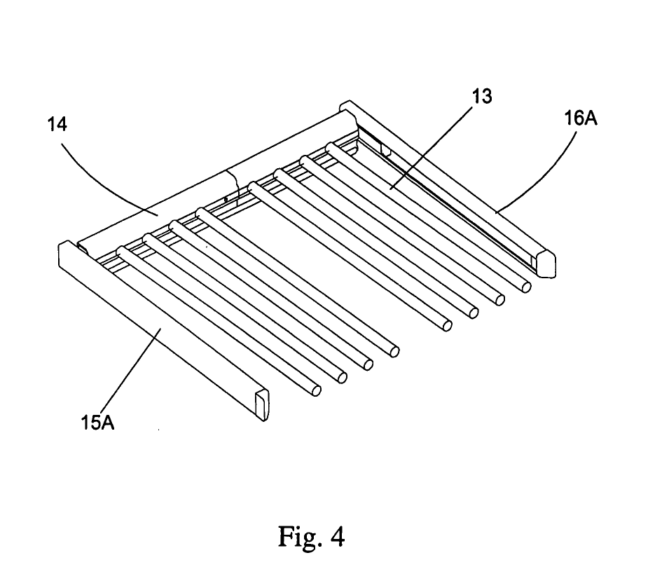

As shown in FIG. 4, the hangers 13 are rods fixed to a U-shaped support 14. Said U-shaped supports 14 are positioned on side guides 15A, 16A, 15B and 16B, shown in FIG. 3, which are disposed on the side walls of the enclosure 2.

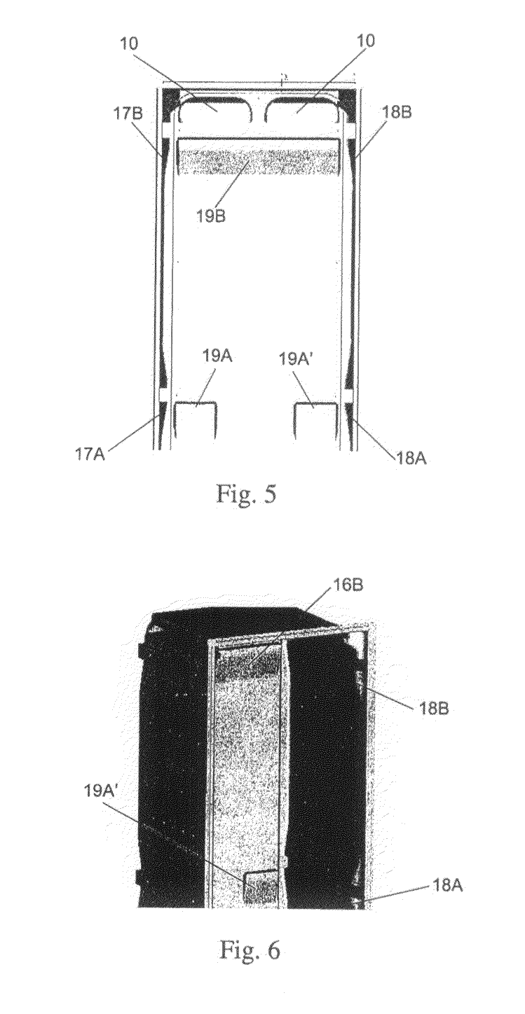

The side walls of the enclosure 2, which is formed by a tub, shown in FIGS. 5 and 6, are such that they form ramps 17A, 18A, 17B and 18B in the lower part of the side guides 15A, 16A, 15B and 16B. Said ramps 17A, 18A, 17B and 18B direct the air flow, also contributing to its homogeneous distribution.

Finally, the rear wall of the enclosure 2 is such that it forms ramps 19A, 19A′ and 19B beneath the U-shaped supports 14 of the hangers 13, directing the air flow towards the clothes. In the lower part, where the U-shaped support 14 of the first row A is positioned, there are two ramps 19A and 19A′ that leave a free intermediate space. It has been proven that this configuration of the ramps 19A and 19A′ also contributes to the homogeneous distribution of the air flow.

1. Clothes drying and dewrinkling cabinet that comprises
a closed and static enclosure that defines an inner space for housing clothes, said inner space comprising a main area with a plurality of hangers;
air supply means for circulating an air flow through said inner space, the air supply means being disposed beneath the inner space;
at least one outlet for the air flow in the upper part of the inner space; and
a small basket for depositing small items of clothing, said small basket being disposed in a substantially horizontal manner in the inner space between the outlet and the main area, and the small basket having a base that covers the transverse surface of the inner space, in such a way that said basket forms, along with the small items of clothing, an air intake area for the air flow that passes through the main area.

2. Cabinet according to the preceding claim, wherein the small basket delimits a central duct.

3. Cabinet according to the preceding claim, wherein the outlet of the air flow is disposed on the rear wall of the enclosure, and the central duct of the small basket is displaced towards said outlet in relation to the geometrical centre of the small basket.

4. Cabinet according to claim 1, wherein the small basket is a basket of rods.

5. Cabinet according to claim 1, wherein the hangers are distributed in at least a first row and a second row disposed at a different height in the inner space, the hangers of the second row being disaligned in relation to the hangers of the first row.

6. Cabinet according to the preceding claim, wherein the hangers are disposed parallel to each other, and the hangers of the second row are above the first row of hangers, the hangers of the second row being positioned in such a way that they leave free spaces above the hangers of the first row.

7. Cabinet according to the preceding claim, wherein the hangers of the second row are equally spaced and there is, beneath each space between consecutive hangers of said second row, one hanger of the first row at most.

8. Cabinet according to claim 5, wherein the first row of hangers is disposed at medium height in the inner space, said hangers being distributed in such a way that they leave a central space free of hangers.

9. Cabinet according to claim 6, wherein the hangers are rods attached to a U-shaped support, said U-shaped support being positioned on side guides disposed on the side walls of the enclosure.

10. Cabinet according to the preceding claim, wherein the side walls of the enclosure are such that they form ramps in the lower part of the side guides.

11. Cabinet according to claim 9, wherein the rear wall of the enclosure is such that it forms ramps beneath the U-shaped supports of the hangers.

12. Cabinet according to the preceding claim, wherein, in the lower part where the U-shaped support of the first row is positioned, there are two ramps that leave a free intermediate space.
